(19) United States
(12) Patent Application Publication
(10) Pub. No.: US 2007/0216359 A1
(43) Pub. Date: Sep. 20, 2007

(54) PULSE CHARGING APPARATUS

(75) Inventors: Shigenori ARAI, Tokyo (JP); Kazuhisa TAKADA, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/686,484

(22) Filed: Mar. 15, 2007

(30) Foreign Application Priority Data
Mar. 16, 2006 (JP) 2006-073445

(51) Int. Cl. H02J 7/00

(52) U.S. Cl. 320/130

(57) ABSTRACT

A pulse charger perform fine control of a charging current according to a battery voltage. The pulse charger includes a switch that turns a charging current from an external power supply on and off. A current detector detects charging current using a current detection resistor. An averaging section averages the output of the current detector. A reference voltage generator generates a reference signal. A comparison section compares an output voltage from the averaging section with the reference signal. A controller controls the switch section based on the output of comparison section. The comparison section includes a comparator that has a hysteresis width. The comparison section outputs an inverse signal between reference voltage and the hysteresis width. The controller performs on/off control of the switch section based on an inverse signal from the comparator and sets an average value of the charging current to a target constant value.

### BACKGROUND OF THE INVENTION

1. Field of the Invention

The present invention relates to a pulse charging apparatus that charges a secondary battery by means of pulse charging, and, for example, to a secondary battery pulse charging apparatus incorporated in a battery pack of a portable device or the like.

2. Description of the Related Art

Secondary batteries, which are storage batteries that can be charged repeatedly, are used in many electronic products such as portable devices and the like. Currently known secondary battery pulse charging apparatuses are those that use a DC-DC converter, and those that use a dropper type constant-voltage control circuit that enables costs to be reduced.

In the case of a portable device such as a mobile phone, considering cases where charging is necessary away from home or the office, it is desirable for a charging apparatus to be incorporated in the battery pack of a mobile phone so as to provide flexible compatibility with a variety of power supplies. However, a charging apparatus that uses a DC-DC converter has a large number of parts, and is therefore difficult to incorporate in a small apparatus such as the battery pack of a mobile phone, and the cost is high. A charging apparatus that uses a dropper type constant-voltage control circuit generates a large amount of heat, and may therefore adversely affect other electronic parts incorporated in the battery pack of a mobile phone.

In Patent Document 1 (Japanese Patent Publication No. 3580828), for example, a pulse charging apparatus is disclosed that has a simpler configuration than a charging apparatus that uses a DC-DC converter, and generates less heat than a charging apparatus that uses a dropper type constant-voltage control circuit.

FIG. 1 is a block diagram showing the configuration of an electronic device that uses a battery pack containing a conventional pulse charging apparatus.

In FIG. 1, reference number 10 denotes a battery pack that supplies power to a portable device 20 in the case of battery drive during handheld use or the like, reference number 20 denotes a portable device equipped with a load circuit 21, and reference number 30 denotes an AC adapter that supplies power to portable device 20 and battery pack 10. AC adapter 30 supplies a direct-current voltage to portable device 20, and also supplies a charging current to battery pack 10.

Battery pack 10 is equipped with a secondary battery 11 composed of three cells B1, B2, and B3 that generate cell voltages V1, V2, and V3; a switch section 12 that turns the charging current supplied to secondary battery 11 on and off; a battery voltage detection section 13 that detects voltages V1, V2, and V3 of cells B1, B2, and B3 of secondary battery 11; an AC adapter connection detection section 14 that detects connection of AC adapter 30; and a pulse charging control section 15 that performs overall battery pack 100 pulse charging control and on/off control of switch section 12.

Pulse charging control section 15 has a configuration comprising a control section 40 composed of switch elements and so forth; a reference voltage generation section 41 that generates a charging control voltage as a reference voltage based on control by control section 40; a voltage comparison section 42 that calculates an average battery voltage Vbatt_ave of battery voltage Vbatt of secondary battery 11 in a stipulated period extending from the present into the past based on battery voltage detection section 13 detection results, and compares the obtained value with the reference voltage; a latch section 43 that latches the fact that average battery voltage Vbatt_ave has become greater than or equal to the charging control voltage as a result of a voltage comparison; a period timer setting section 44 that sets a charging period T; and a duty timer setting section 45 that sets an on-duty time D×T determined by the product of a stipulated charging period T and on-duty factor D.

When charging is started, period T is set by period timer setting section 44 and on-duty time D×T is set by duty timer setting section 45. In accordance with the set period T and on-duty time D×T, switch section 12 repeats on/off operations, and operation is performed so that decreasing of on-duty factor D begins from period T immediately after it is detected that average battery voltage Vbatt_ave is greater than or equal to the reference voltage generated by reference voltage generation section 41, and charging is terminated when on-duty factor D becomes less than a stipulated value. A pulse charging apparatus with the above-described configuration can charge secondary battery 11 with a simpler configuration than a pulse charging apparatus that uses a DC-DC converter. Also, since charging is controlled by turning the supplied current on and off, charging can be performed with less heat generation than a pulse charging apparatus that uses a dropper type constant-voltage control circuit.

There is an appropriate value for a charging current supplied to a secondary battery, according to the type and battery voltage of the secondary battery. If a charging current exceeding the appropriate value is supplied, there is a risk of the secondary battery deteriorating. Also, if the charging current is too far below the appropriate value, there is a problem of the charging time becoming lengthy.

Although the pulse charging apparatus described in Patent Document 1 enables a short charging time to be achieved inexpensively and with little heat generation, since on/off control of the charging current supplied to the secondary battery is based on the secondary battery's battery voltage detection results, fine charging current control such that the average charging current coincides with the appropriate value is difficult. Therefore, depending on the connected power supply, there is a risk that the charging current will greatly exceed the appropriate value and deterioration of the secondary battery will be caused.

### SUMMARY OF THE INVENTION

It is an object of the present invention to provide a pulse charging apparatus that enables the charging current to be finely controlled according to the battery voltage.

According to an aspect of the invention, a pulse charging apparatus includes: a switch section that turns a charging current from a direct-current source on and off; a current detection section that detects the charging current; an averaging section that averages output of the current detection section; a reference signal generation section that generates a reference signal; a comparison section that compares output of the averaging section with the reference signal; and a control section that controls the switch section based on output of the comparison section.

According to another aspect of the invention, a pulse charging apparatus includes: a switch section that turns a charging current from a direct-current source on and off; a current detection section that detects the charging current; a voltage averaging section that smoothes output of the current detection section; a triangular wave generation section that generates a triangular wave signal; a comparison section that compares output of the voltage averaging section with the triangular wave signal; and a control section that controls the switch section based on output of the comparison section.

### BRIEF DESCRIPTION OF THE DRAWINGS

The above and other objects and features of the invention will appear more fully hereinafter from a consideration of the following description taken in conjunction with the accompanying drawing wherein one example is illustrated by way of example, in which:

FIG. 1 is a block diagram showing the configuration of an electronic device that uses a battery pack containing a conventional pulse charging apparatus;

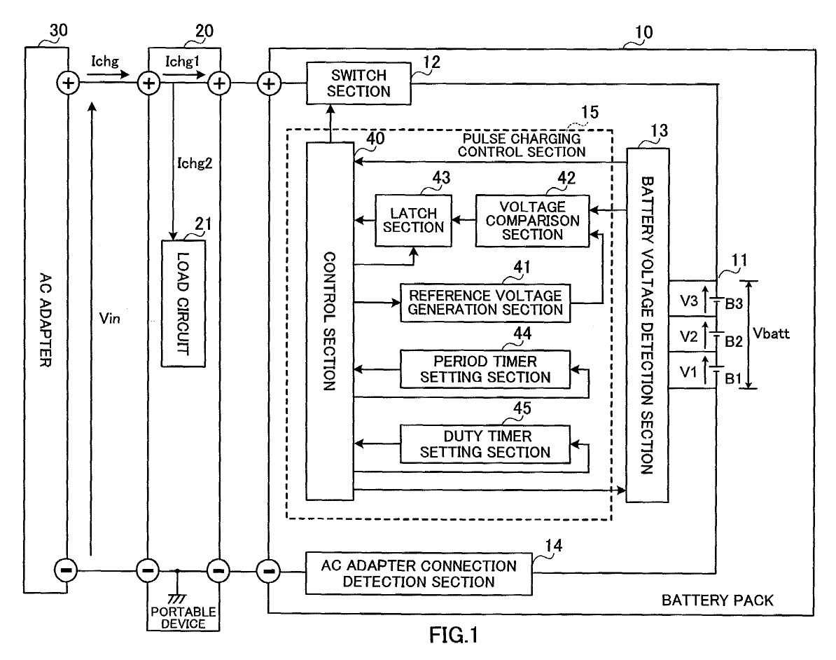

FIG. 2 is a block diagram showing the configuration of a pulse charging apparatus according to Embodiment 1 of the present invention;

FIG. 3 is a circuit diagram showing the detailed configuration of a pulse charging apparatus according to above Embodiment 1;

FIG. 4 is a characteristic graph showing the output characteristic of an external power supply of a pulse charging apparatus according to above Embodiment 1;

FIG. 5 shows operational waveform diagrams of each section of a pulse charging apparatus according to above Embodiment 1;

FIG. 6 is a block diagram showing the configuration of a pulse charging apparatus according to Embodiment 2 of the present invention;

FIG. 7 is a circuit diagram showing the detailed configuration of a pulse charging apparatus according to above Embodiment 2; and

FIG. 8 shows operational waveform diagrams of each section of a pulse charging apparatus according to above Embodiment 2.

### DESCRIPTION OF THE PREFERRED EMBODIMENTS

With reference now to the accompanying drawings, embodiments of the present invention will be explained in detail below.

### Embodiment 1

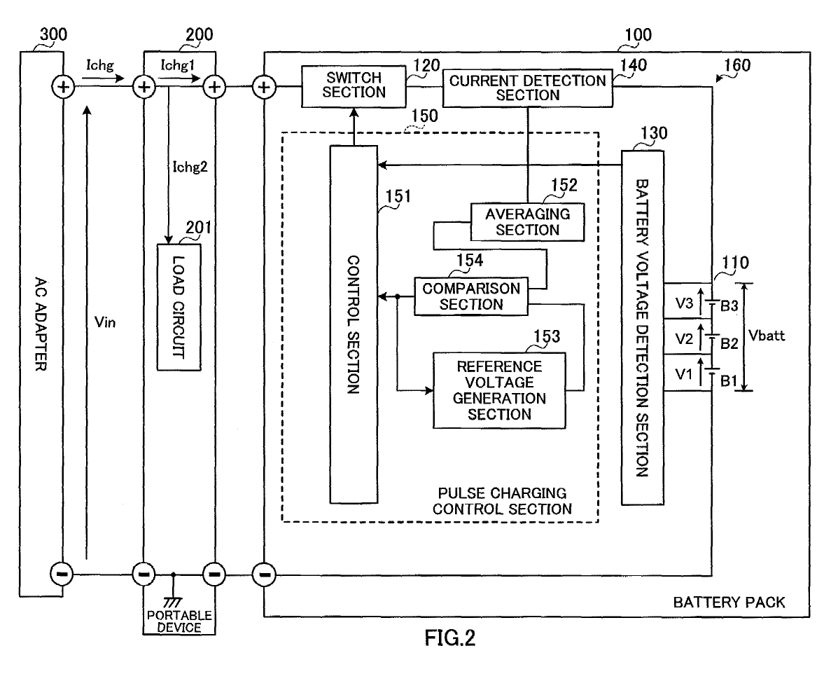

FIG. 2 is a block diagram showing the configuration of a pulse charging apparatus according to Embodiment 1 of the present invention. This embodiment is an example in which a pulse charging apparatus is applied to a battery pack installed in a portable device.

In FIG. 2, reference number 100 denotes a battery pack that includes a pulse charging apparatus, reference number 200 denotes a portable device such as a mobile phone equipped with a load circuit 201, and reference number 300 denotes an AC adapter that has the capability of supplying a charging current Ichg as a charging power supply. A direct-current voltage Vin output from AC adapter 300 is supplied to portable device 200, and a charging current is supplied to battery pack 100.

AC adapter 300 converts a commercial AC power supply to direct-current voltage Vin, and supplies direct-current voltage Vin to portable device 200 and battery pack 100. AC adapter 300 supplies charging current Ichg to portable device 200 and battery pack 100; or more specifically, of charging current Ichg, a charging current Ichg1 is supplied to battery pack 100, and a charging current Ichg2 is supplied to load circuit 201. Since a characteristic of this embodiment is pulse charging control for charging battery pack 100, for the sake of explanation no distinction is made between charging current Ichg and charging current Ichg1, and charging current Ichg1 is treated entirely as charging current Ichg.

Battery pack 100 has a configuration comprising a secondary battery 110 composed of three cells B1, B2, and B3 that generate cell voltages V1, V2, and V3; a switch section 120 that turns the charging current supplied to secondary battery 110 on and off; a battery voltage detection section 130 that detects secondary battery 110 battery voltage Vbatt, the sum of voltages V1, V2, and V3 of cells B1, B2, and B3 of secondary battery 110; a current detection section 140 that detects a charging current that charges secondary battery 110; and a pulse charging control section 150 that performs overall battery pack 100 pulse charging control and on/off control of switch section 120.

Above-described switch section 120, battery voltage detection section 130, current detection section 140, and pulse charging control section 150 make up a pulse charging apparatus 160.

Pulse charging control section 150 has a configuration comprising a control section 151 that performs on/off control of switch section 120; an averaging section 152 that averages a signal detected by current detection section 140; a reference voltage generation section 153 that generates a reference voltage; and a comparison section 154 that compares an output signal from averaging section 152 with an output signal from reference voltage generation section 153.

Battery voltage detection section 130 detects a voltage Vbatt of secondary battery 110, and detects that the battery voltage has been charged up to a predetermined battery voltage.

Control section 151 performs on/off control of switch section 120 based on an inverse signal from comparison section 154, and performs control to make a charging current from a direct-current source as an average charging current.

Reference voltage generation section 153 generates a reference voltage that is the reference value for the average charging current. For the reference voltage, it is preferable to be able to vary the reference voltage generated according to a control section 151 setting.

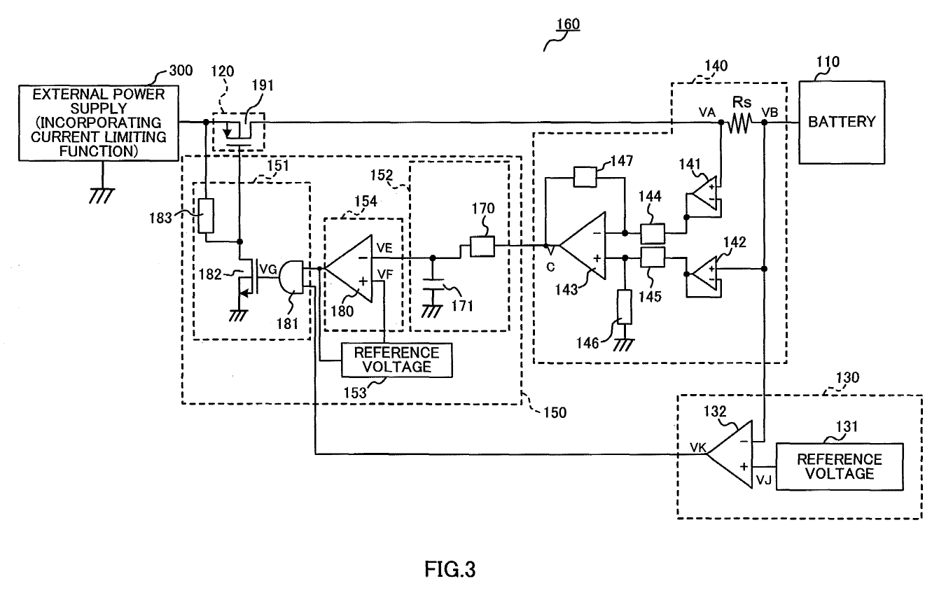

Comparison section 154 is equipped with a comparator 180 (shown later herein in FIG. 3) that has a hysteresis width, and outputs an inverse signal between the reference voltage from reference voltage generation section 153 and the hysteresis width. Pulse control is performed by means of a signal VG that is output based on this inverse signal.

FIG. 3 is a circuit diagram showing the detailed configuration of above-described pulse charging apparatus 160.

In FIG. 3, AC adapter 300 is taken to be an external power supply from the viewpoint of pulse charging apparatus 160. Hereinafter, AC adapter 300 will be referred to as external power supply 300. Switch section 120 comprises a PMOS transistor 191, for example, in which the source is connected to AC adapter 300 and the drain is connected to secondary battery 110, and a control section 151 control signal is received at the gate. PMOS transistor 191 is turned on and off by a control signal output from control section 151, and turns a charging current from external power supply 300 on and off.

Battery voltage detection section 130 is composed of a reference voltage generation section 131 that generates a reference voltage VJ, and a comparator 132 that compares voltage VJ output from reference voltage generation section 131 with a battery voltage VB. In battery voltage detection section 130, when battery voltage VB becomes greater than or equal to charging-completion reference voltage VJ, comparator 132 output VK changes, and control section 151 detects the change of comparator 132 output VK, stops switch section 120 on/off control, and stops the charging current from external power supply 300.

Current detection section 140 is composed of a current detection resistor Rs inserted between external power supply 300 and secondary battery 110, a buffer 141 comprising an operational amplifier that performs impedance conversion of current detection resistance Rs external power supply 300 side voltage VA, a buffer 142 that performs impedance conversion of current detection resistor Rs secondary battery 110 side voltage VB, a differential amplifier 143, and resistors 144 through 147. If the resistance values of resistors 144 through 147 of differential amplifier 143 are the same, the difference between VA and VB (VA−VB) is output as differential amplifier 143 output voltage VC. By performing impedance conversion of current detection resistor Rs voltages VA and VB, and inputting the results to differential amplifier 143, the voltage difference between the two sides of current detection resistor Rs (VA−VB) can be detected while minimizing the effect on the charging current.

Pulse charging control section 150 is composed of control section 151, averaging section 152, reference voltage generation section 153 that generates a reference voltage VF, and comparison section 154.

Averaging section 152 is a CR integrating circuit composed of a resistor 170 and a capacitor 171 that smoothes current detection section 140 output voltage VC and outputs a voltage VE.

Comparison section 154 comprises comparator 180 having a hysteresis width Vhys for generating pulses, and comparator 180 compares averaging section 152 output voltage VE with reference voltage VF.

Control section 151 is composed of an AND gate circuit 181, an NMOS transistor 182 for turning PMOS transistor 191 of switch section 120 on and off, and a pull-up resistor 183. AND gate circuit 181 ANDs an output signal from comparator 180 of comparison section 154 and output signal VK from comparator 132 of battery voltage detection section 130, and outputs an output signal VG to the gate of NMOS transistor 182. As output signal VK output from comparator 132 of battery voltage detection section 130 is high until battery voltage VB becomes greater than or equal to charging-completion reference voltage VJ—that is, during the charging period—NMOS transistor 182 is turned on and off by receiving the comparison section 154 output signal at its gate as a control signal. Pull-up resistor 183 is for turning off PMOS transistor 191 by making the gate potential and source potential of PMOS transistor 191 the same when NMOS transistor 182 is off.

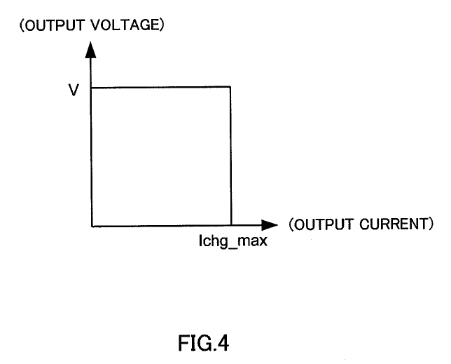

FIG. 4 is a characteristic graph showing the output characteristic of external power supply 300. The AC adapter comprising external power supply 300 is provided with a current limiting function as an overload protection function, and the maximum output current value is charging current maximum value Ichg_max.

The operation of pulse charging apparatus 160 configured as described will now be explained. First, the overall operation of pulse charging apparatus 160 will be described.

Charging current Ichg is supplied to secondary battery 110 from external power supply 300 (a direct-current source) as a charging power supply. Control section 151 performs switch section 120 on/off control, and switch section 120 receives a control signal from control section 151 and turns the charging current from the direct-current source on and off. Current detection section 140 is located between the direct-current source and secondary battery 110, and detects charging current Ichg that charges secondary battery 110. Signal VC detected by current detection section 140 is averaged by averaging section 152, and an averaged signal VE is compared with reference voltage VF from reference voltage generation section 153 by comparison section 154. Comparison section 154 is provided with comparator 180 (FIG. 3) having hysteresis width Vhys, and outputs an inverse signal between reference voltage VF from reference voltage generation section 153 and hysteresis width Vhys. Control section 151 performs pulse control by turning a control transistor on and off by means of signal VG output based on this inverse signal. Pulse control implemented by this means comprises supply and constant-current implementation of charging current Ichg average charging current Ichg_ave. Also, battery voltage detection section 130 detects secondary battery 110 voltage Vbatt, and when the battery voltage has been charged up to a predetermined battery voltage, outputs a control signal (or change-of-state signal) to control section 151. Control section 151 receives a control signal from battery voltage detection section 130 and turns switch section 120 off. By this means, charging by the pulse charging current is stopped.

A description will now be given of the conversion of charging current Ichg to an average charging current by pulse charging apparatus 160, and the process of making that average charging current a constant current.

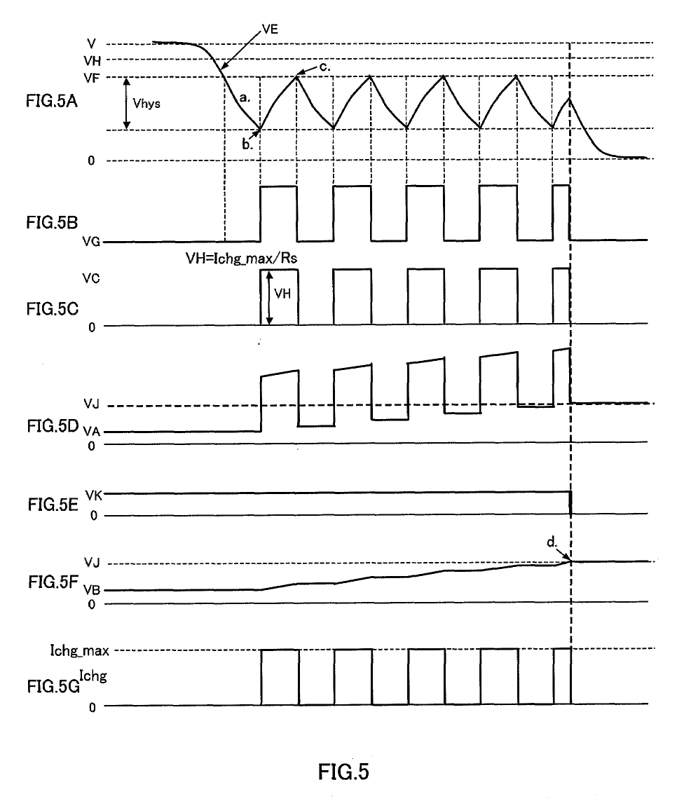

FIG. 5 shows operational waveform diagrams of each section of pulse charging apparatus 160. FIG. 5A shows the operational waveforms of signal VE (the comparator 180 input terminal voltage) resulting from smoothing of differential amplifier 143 output voltage VC and reference voltage VF from reference voltage generation section 153, FIG. 5B shows the operational waveform of AND gate circuit 181 output signal VG (the comparator 180 output signal during charging), FIG. 5C shows the operational waveform of amplifier 143 output voltage VC, FIG. 5D shows the operational waveform of current detection resistor Rs external power supply side voltage VA, FIG. 5E shows the operational waveform of battery voltage detection section 130 comparator 132 output VK, FIG. 5F shows current detection resistor Rs battery side voltage VB, and FIG. 5G shows charging current Ichg.

As shown in FIG. 5A and FIG. 5B, when charging is started, a charge is accumulated in capacitor 171, and when comparator 180 input terminal voltage VE is higher than reference voltage VF, the output signal of comparator 180 during charging is low, and output signal VG of AND gate circuit 181 that generates the ANDed output of the comparator 180 output signal is low, and therefore NMOS transistor 182 and PMOS transistor 191 are turned off, charging current Ichg does not flow, and voltages VA and VB at the two sides of current detection resistor Rs are equal. That is to say, since VC=0, as shown in FIG. 5C, VE gradually decreases through the operation of averaging section 152 (see FIG. 5A).

When the VE voltage decreases to VF−Vhys, the voltage at which comparator 180 output signal VG is inverted (see FIG. 5B), comparator 180 output signal VG is inverted from the low level to the high level, and therefore charging current Ichg flows, as shown in FIG. 5G. That is to say, when output signal VG of comparator 180 during charging goes high, NMOS transistor 182 is turned on, the drain potential of NMOS transistor 182 goes low and PMOS transistor 191 that receives the drain potential of NMOS transistor 182 at its gate is turned on, and charging current Ichg flows from external power supply 300 to secondary battery 110. At this time, charging current Ichg is limited by the maximum output current value as shown in FIG. 4, and therefore charging current Ichg becomes equal to Ichg_max.

When charging current Ichg flows, if the resistance value of current detection resistor Rs is denoted by Rs, current detection resistor Rs external power supply side voltage VA is given by following Equation (1).

VA=VB+Ichg×Rs (1)

Designating Ichg×Rs as VH in above Equation (1), differential amplifier 143 output voltage VC is given by following Equation (2).

VC=VH (2)

If VH is higher than VF, since VE gradually approaches VC (=VH) through the operation of averaging section 152, VE necessarily intersects VF (see FIG. 5C), and comparator 180 output VG is inverted from the high level to the low level at that point of intersection. Then, since charging current Ichg does not flow, VC becomes 0, and signal VE resulting from smoothing differential amplifier 143 output voltage VC gradually decreases through the operation of averaging section 152.

Through repetition of this operation, signal VE resulting from smoothing differential amplifier 143 output voltage VC fluctuates between reference voltage VF and (VF−Vhys) (see FIG. 5A). Above-described hysteresis width Vhys is provided by comparator 180 having hysteresis width Vhys, and pulses are generated in accordance with this hysteresis width Vhys. An example of pulse generation without using hysteresis width Vhys is described in Embodiment 2 later herein. If the resistance value of resistor 170 is designated R, and the capacitance of capacitor 171 is designated C, an increase of signal VE has a gradient of approximately {VH−(VF−Vhys)}/(CR), and a decrease has a gradient of approximately −VF/(CR). Therefore, average value Ichg_ave of charging current Ichg is given by following Equation (3).

Ichg_{—}ave=VF×Ichg_max/(Rs×Ichg_max+Vhys) (3)

As hysteresis width Vhys is usually minute, average charging current Ichg_ave is approximately as given by Equation (4).

Ichg_{—}ave=VF/Rs (4)

Through fluctuation of averaging section 152 output voltage VE between reference voltage VF and (VF−Vhys), pulse charging current Ichg shown in FIG. 5G flows, and secondary battery 110 is charged. As secondary battery 110 is charged, the voltage level of current detection resistor Rs secondary battery 110 side voltage VB rises as shown in FIG. 5F, and the average level of current detection resistor Rs external power supply side voltage VA also rises as shown in FIG. 5D. When the voltage level of voltage VB reaches charging-completion reference voltage VJ of reference voltage generation section 131 in battery voltage detection section 130 (see FIG. 5D), comparator 132 output VK changes from the high level to the low level as shown in FIG. 5E, and output VG of AND gate circuit 181 in control section 151 goes low regardless of the output level of comparison section 154. As a result, NMOS transistor 182 and PMOS transistor 191 are turned off, charging current Ichg does not flow, and charging of secondary battery 110 ends.

As described above, according to this embodiment, pulse charging apparatus 160 is equipped with switch section 120 that turns a charging current from external power supply 300 on and off, current detection section 140 that detects charging current Ichg by means of current detection resistor Rs, averaging section 152 that averages current detection section 140 output, reference voltage generation section 153 that generates reference signal VF, and comparison section 154 that compares averaging section 152 output voltage VE with reference signal VF; comparison section 154 comprises comparator 180 that has hysteresis width Vhys, and outputs an inverse signal between reference voltage VF and hysteresis width Vhys; and control section 151 performs on/off control of switch section 120 based on an inverse signal from comparator 180; by which means pulse control is performed so that charging current Ichg keeps within a fixed level range, and average value Ichg_ave of charging current Ichg is set to a target fixed value. By this means, a pulse charging current can be supplied such that average value Ichg_ave of charging current Ichg is made a constant current. The above-described pulse control can first be implemented by detecting charging current Ichg and feeding back this detection information to control section 151. That is to say, when only detection of the battery voltage is performed, as in the example of the prior art, the battery charging status cannot be clearly ascertained, and it is difficult to achieve fine control of the charging current such that the average charging current is made to coincide with an appropriate value. In contrast, with this pulse charging control, the battery voltage of secondary battery 110 being charged can be ascertained as the battery charging status by detecting charging current Ichg.

Reference voltage VF generated by reference voltage generation section 153 can be changed by means of a directive from control section 151. For example, if provision is made for reference voltage VF to be adjusted according to battery voltage Vbatt, a more appropriate pulse charging current can be supplied according to the battery charging status. In this embodiment, also, battery voltage detection section 130 detects secondary battery 110 battery voltage VB, and this is used as a charging-completion condition for pulse charging control.

Since average charging current Ichg_ave can be finely controlled according to the battery voltage, as described above, it is possible to prevent the problem of an excessively large current flowing in the battery, resulting in deterioration of the battery. Also, since fine control is possible, shortening of the charging time can be expected. Furthermore, charging can be performed with less heat generation than in the case of a dropper type charging apparatus.

In this embodiment, reference voltage VF is set lower than VH shown in FIG. 5 But if provision is made for VF to be set higher than VH, signal VE does not reach signal VF, and signal VG is always high. As a result, switch section 120 is fixed in the on state, and charging current Ichg can be kept constantly at Ichg_max.

The frequency of pulse charging current Ichg can be adjusted by means of the CR time constants of resistor 170 and capacitor 171 in averaging section 152, and hysteresis width Vhys of comparator 180.

### Embodiment 2

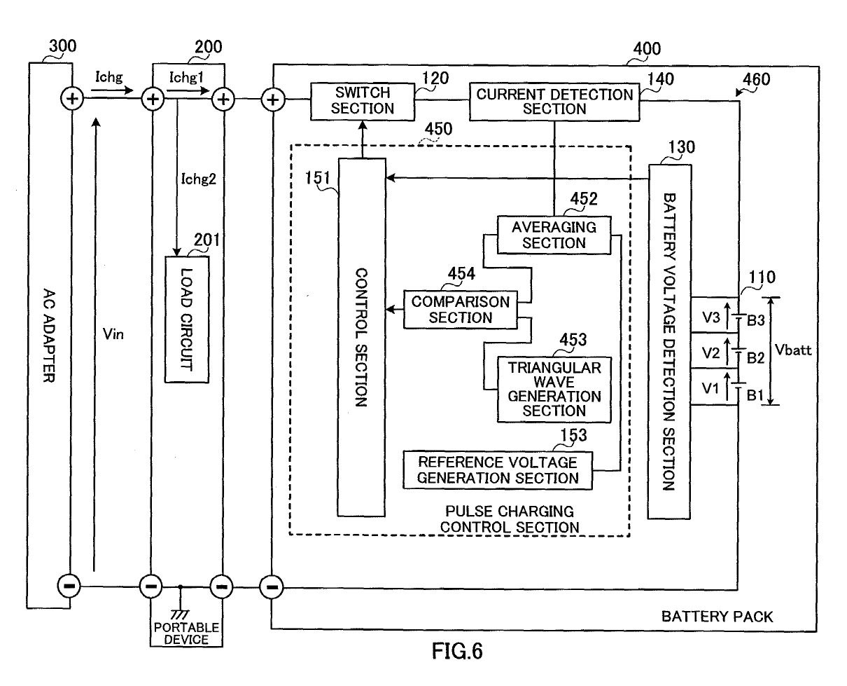

FIG. 6 is a block diagram showing the configuration of a pulse charging apparatus according to Embodiment 2 of the present invention. In the description of this embodiment, parts identical to those in FIG. 2 are assigned the same codes as in FIG. 2 and duplicate descriptions are omitted.

In FIG. 6, reference number 400 denotes a battery pack that includes a pulse charging apparatus, reference number 200 denotes a portable device such as a mobile phone equipped with a load circuit 201, and reference number 300 denotes an AC adapter that has the capability of supplying a charging current Ichg as a charging power supply. A direct-current voltage Vin output from AC adapter 300 is supplied to portable device 200, and a charging current is supplied to battery pack 400.

Battery pack 400 has a configuration comprising a secondary battery 110 composed of three cells B1, B2, and B3 that generate cell voltages V1, V2, and V3; a switch section 120 that turns the charging current supplied to secondary battery 110 on and off; a cell voltage detection section 130 that detects voltages V1, V2, and V3 of cells B1, B2, and B3 of secondary battery 110; a current detection section 140 that detects a charging current that charges secondary battery 110; and a pulse charging control section 450 that performs overall battery pack 400 pulse charging control and on/off control of switch section 120.

Above-described switch section 120, battery voltage detection section 130, current detection section 140, and pulse charging control section 450 make up a pulse charging apparatus 460.

Pulse charging control section 450 has a configuration comprising a control section 151 that performs on/off control of switch section 120; a reference voltage generation section 153 that generates a reference voltage; an averaging section 452 that averages a signal detected by current detection section 140 and compares the result with output signal VF from reference voltage generation section 153; a triangular wave generation section 453 that generates a triangular wave signal VT; and a comparison section 454 that compares signal VE from averaging section 152 with triangular wave signal VT from triangular wave generation section 453. Although triangular wave signal VT is generated by triangular wave generation section 453, it goes without saying that the term “triangular wave” is used for convenience, and is a concept that includes a sawtooth wave.

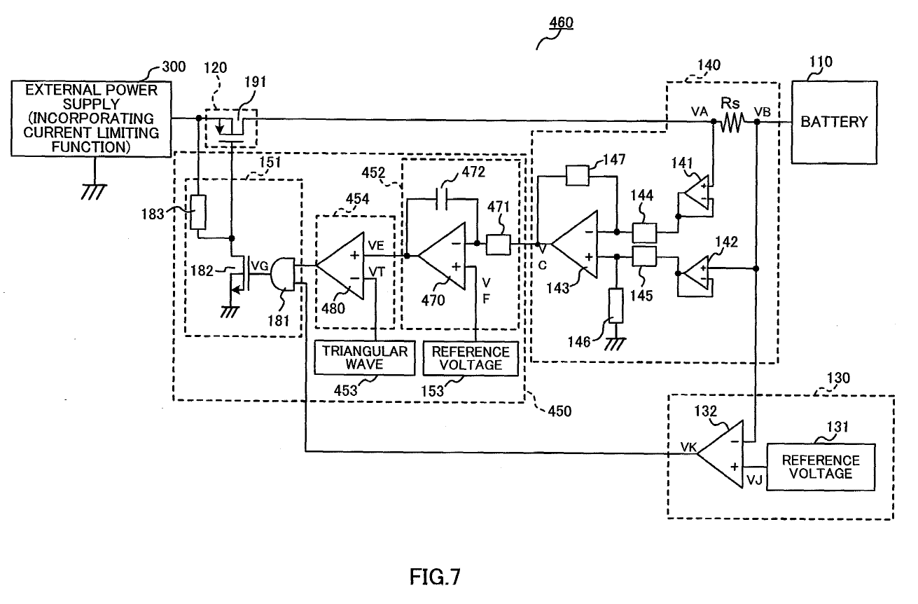

FIG. 7 is a circuit diagram showing the detailed configuration of above-described pulse charging apparatus 460. Parts identical to those in FIG. 3 are assigned the same codes as in FIG. 3 and duplicate descriptions are omitted.

In FIG. 7, pulse charging control section 450 is composed of control section 151, reference voltage generation section 153, averaging section 452, triangular wave generation section 453, and comparison section 454.

Averaging section 452 comprises an integrator composed of a differential amplifier 470, a resistor 471, and a feedback capacitance 472, and averages a signal detected by current detection section 140, compares the result with reference voltage VF from reference voltage generation section 153, and outputs signal VE.

Comparison section 454 comprises a comparator 480 that compares signal VE from averaging section 452 with triangular wave signal VT from triangular wave generation section 453, and outputs signal VG that drives NMOS transistor 182 of control section 151 to AND gate circuit 181. Comparator 480 does not have hysteresis.

The operation of a pulse charging apparatus configured as described will now be explained.

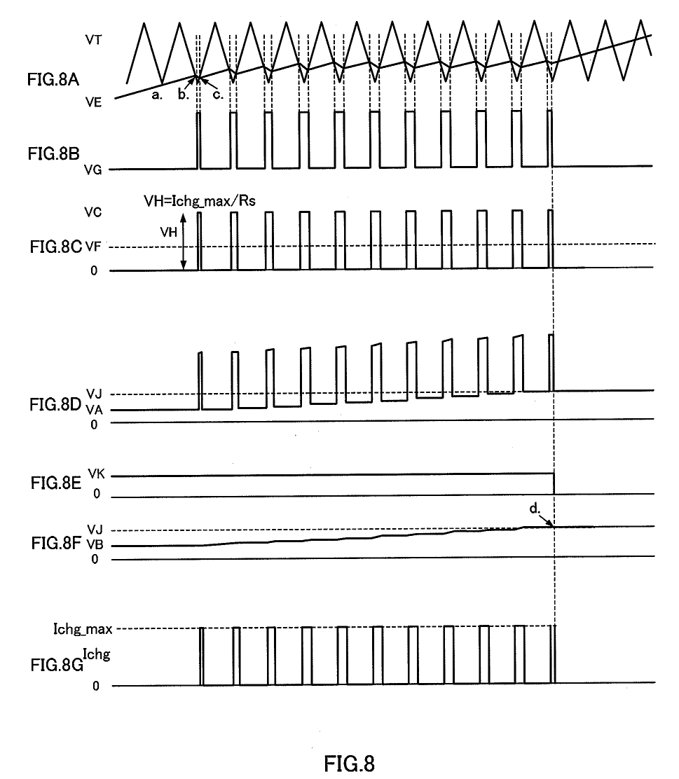

FIG. 8 shows operational waveform diagrams of each section of pulse charging apparatus 460. FIG. 8A shows the operational waveforms of signal VE (the comparator 480 input terminal voltage) obtained by integrating differential amplifier 143 output voltage VC, and triangular wave signal VT, FIG. 8B shows the operational waveform of AND gate circuit 181 output signal VG (the comparator 180 output signal during charging), FIG. 8C shows the operational waveform of amplifier 143 output voltage VC, FIG. 8D shows the operational waveform of current detection resistor Rs external power supply side voltage VA, FIG. 8E shows the operational waveform of battery voltage detection section 130 comparator 132 output VK, FIG. 8F shows current detection resistor Rs battery side voltage VB, and FIG. 8G shows charging current Ichg.

As shown in FIG. 8A and FIG. 8B, when charging is started, a charge is accumulated in capacitor 171, and if signal VE resulting from integrating differential amplifier 143 output voltage VC is lower than triangular wave signal VT, the output signal of comparator 180 during charging is low, and output signal VG of AND gate circuit 181 that generates the ANDed output of the comparator 180 output signal is low, and therefore NMOS transistor 182 and PMOS transistor 191 are turned off, charging current Ichg does not flow, and voltages VA and VB at the two sides of current detection resistor Rs are equal. That is to say, since VC=0, as shown in FIG. 8C, VE gradually increases through the operation of averaging section 452 (see FIG. 8A).

When the VE voltage increases to triangular wave signal VT (see FIG. 8B), comparator 480 output signal VG is inverted from the high level to the low level, and therefore charging current Ichg flows, as shown in FIG. 8G. That is to say, when output signal VG of comparator 480 during charging goes high, NMOS transistor 182 is turned on, the drain potential of NMOS transistor 182 goes low and PMOS transistor 191 that receives the drain potential of NMOS transistor 182 at its gate is turned on, and charging current Ichg flows from external power supply 300 to secondary battery 110. At this time, charging current Ichg is limited by the maximum output current value as shown in FIG. 4, and therefore charging current Ichg becomes equal to Ichg_max.

When charging current Ichg flows, if the resistance value of current detection resistor Rs is denoted by Rs, current detection resistor Rs external power supply side voltage VA is given by Equation (1) above.

Designating Ichg×Rs as VH in above Equation (1), differential amplifier 143 output voltage VC is given by Equation (2) above.

If VH is higher than VF, since VE gradually decreases through the operation of averaging section 452, VE necessarily intersects VF (see FIG. 8C), and comparator 480 output VG is inverted from the high level to the low level at that point of intersection. Then, since charging current Ichg does not flow, VC becomes 0, and signal VE resulting from integration of differential amplifier 143 output voltage VC gradually increases through the operation of averaging section 452.

If the resistance value of resistor 170 is designated R, and the capacitance of capacitor 171 is designated C, an increase of signal VE has a gradient of VH/(CR), and a decrease has a gradient of (VF−VH)/(CR). Also, if triangular wave signal VT fluctuates at equal times between VT1 and VT2 (VT1>VT2) in period T, charging current average value Ichg_ave is given approximately by following Equation (5).

Ichg_{—}ave=VF/Rs (5)

As described above, charging current average value Ichg_ave can be set to a fixed value by means of reference voltage VF and detection resistor Rs. Furthermore, as reference voltage VF is adjusted by control section 151 according to battery voltage Vbatt, a pulse charging apparatus of this Embodiment 2 can supply a pulse charging current whose average value is made a constant current according to the charging status of the battery.

Thus, output signal VG of comparator 480 is generated by means of averaging section 452 output voltage VE and triangular wave signal VT, and by means of this output signal VG with a fluctuating pulse width, pulse charging current Ichg shown in FIG. 8G flows, and secondary battery 110 is charged. As secondary battery 110 is charged, the voltage level of current detection resistor Rs secondary battery 110 side voltage VB rises as shown in FIG. 8F, and the average level of current detection resistor Rs external power supply side voltage VA also rises as shown in FIG. 8D. When the voltage level of voltage VB reaches charging-completion reference voltage VJ of reference voltage generation section 131 in battery voltage detection section 130 (see FIG. 8D), comparator 132 output VK changes from the high level to the low level as shown in FIG. 8E, and output VG of AND gate circuit 181 in control section 151 goes low regardless of the output level of comparison section 454. As a result, NMOS transistor 182 and PMOS transistor 191 are turned off, charging current Ichg does not flow, and charging of secondary battery 110 ends.

Thus, according to this embodiment, average value Ichg_ave of charging current Ichg can be set to a target fixed value, and the same kind of effect as in Embodiment 1 can be achieved—that is, by means of fine control of the charging current, it is possible to prevent the problem of an excessively large current flowing in the battery, resulting in deterioration of the battery, and the charging time can be shortened.

In this embodiment, reference voltage VF is set lower than VH shown in FIG. 8, but if provision is made for reference voltage VF to be set higher than VH, signal VE will continue to increase and will eventually become higher than triangular wave signal VT. As a result, signal VG is constantly high, switch section 120 is fixed in the on state, and the charging current can be kept constantly at Ichg_max.

It is self-evident that the frequency of the pulse charging current is equal to the frequency of triangular wave signal VT, and can therefore be adjusted by adjusting the frequency of triangular wave signal VT by means of control section 151. Although not shown, a timer that measures the charging time is actually provided inside battery pack 400 in FIG. 6, and this timer has a triangular wave generation circuit that generates triangular wave signal VT. Therefore, triangular wave generation section 453 can use this triangular wave generation circuit, requiring no increase in the number of parts.

The above description presents examples of suitable embodiments, but the scope of the present invention is not limited to these examples. For example, while the embodiments refer to the case of a battery pack, the same kind of effect can also be obtained in the case of a charger.

Also, while the term “pulse charging apparatus” is used in the above embodiments, this is for the sake of explanation, and such terms as “charging apparatus,” “charger,” “pulse charging method,” and the like may of course also be used.

Furthermore, the type, number, connection method, and so forth of component circuit blocks of the above-described pulse charging apparatuses—such as a switch element, for example—are not limited to those in the above-described embodiments. While a MOS transistor, for example, is generally used as a switch element, any kind of element that performs a switching operation may be used.

As described above, according to the present invention, the average charging current can be finely controlled according to the battery voltage, and it is possible to prevent the problem of an excessively large current flowing in the battery, resulting in deterioration of the battery. Also, since fine pulse charging control is possible, shortening of the charging time can be expected. Furthermore, charging can be performed with less heat generation than in the case of a dropper type charging apparatus.

Therefore, a pulse charging apparatus according to the present invention is useful as a battery charging system for a portable device or the like. A pulse charging apparatus according to the present invention can also be widely applied to chargers in electronic devices other than portable devices.

The present invention is not limited to the above-described embodiments, and various variations and modifications may be possible without departing from the scope of the present invention.

This application is based on Japanese Patent Application No. 2006-073445 Filed on Mar. 16, 2006, the entire content of which is expressly incorporated by reference herein.

What is claimed is:

1. A pulse charging apparatus comprising:
a switch section that turns a charging current from a direct-current source on and off;
a current detection section that detects the charging current;
an averaging section that averages output of the current detection section;
a reference signal generation section that generates a reference signal;
a comparison section that compares output of the averaging section with the reference signal; and
a control section that controls the switch section based on output of the comparison section.

2. A pulse charging apparatus comprising:
a switch section that turns a charging current from a direct-current source on and off;
a current detection section that detects the charging current;
a voltage averaging section that smoothes output of the current detection section;
a triangular wave generation section that generates a triangular wave signal;
a comparison section that compares output of the voltage averaging section with the triangular wave signal; and
a control section that controls the switch section based on output of the comparison section.

3. The pulse charging apparatus according to claim 1, wherein:
the comparison section is composed of a comparator having a hysteresis width, and outputs an inverse signal between the reference voltage and the hysteresis width; and
the control section performs on/off control of the switch section based on the inverse signal from the comparator, and makes a charging current from the direct-current source a constant current as an average charging current.

4. The pulse charging apparatus according to claim 2, wherein:
the comparison section compares a signal smoothed by the voltage averaging section with the triangular wave signal and outputs an inverse signal; and
the control section performs on/off control of the switch section based on the inverse signal from the comparator, and makes a charging current from the direct-current source a constant current as an average charging current.

5. The pulse charging apparatus according to claim 2, wherein the voltage averaging section has an integrating circuit that smoothes output of the voltage detection section.

6. The pulse charging apparatus according to claim 1, further comprising a battery voltage detection section that detects a battery voltage of a secondary battery;
wherein the control section performs control that turns the switch section off when a predetermined battery voltage is detected by the battery voltage detection section.
